(19) United States
(12) Patent Application Publication
(10) Pub. No.: US 2002/0056809 A1
(43) Pub. Date: May 16, 2002

(54) Armored rock detector

(76) Inventors: Larry D. Frederick, Huntsville, AL (US); Dwight Medley, Kelso, TN (US)

Correspondence Address: DICKSTEIN SHAPIRO MORIN & OSHINSKY LLP, 2101 L STREET NW, WASHINGTON, DC, 20037-1526, US

(21) Appl. No.: 09/811,781

(22) Filed: Mar. 20, 2001

Related U.S. Application Data
(60) Provisional application No. 60/238,127, filed on Oct. 6, 2000.

(51) Int. Cl. G01T 1/20

(52) U.S. Cl. 250/361 R

(57) ABSTRACT

An armored gamma detector, mining system, and methods of use are described. The gamma detector includes a scintillation element, a window, and a photo-metric module, including a photomultiplier tube and a logic element. The photo-metric module and window are encased within an explosion-proof housing. The scintillation element is encased within a housing having at least one window which may be made of a material including polyether ethyl ketone. The logic element is adapted to determine the amount of gamma radiation detected over a predetermined time period, as well as a running average of the amount of gamma radiation detected over the time period. In one embodiment, a pair of gamma detectors may be used in tandem to determine the position of the cutting drum of the mining equipment relative to the boundary between the ore vein being cut through and adjacent rock strata.

This application claims priority from U.S. patent application Ser. No. 09/471,122, filed Dec. 23, 1999, U.S. patent application Ser. No. 09/626,744, filed July 26, 2000, and U.S. provisional application serial No. 60/238,127, filed Oct. 6, 2000, all of which are incorporated by reference herein in their entirities.

### BACKGROUND

The invention generally relates to an apparatus for detecting the presence of rock during coal or ore mining operations or the presence of hydrocarbons during drilling operations.

Nuclear detectors, such as gamma detectors, have been used in mining applications and drilling operations for many years. In particular, gamma detectors have been used to measure the radiation that emanates from the formations surrounding the mining or drilling equipment. Such gamma detectors operate by utilizing the differences between the natural radioactivity of the target formation and the natural radioactivity of the adjacent formations to determine the boundaries between these formations.

For example, a coal seam is generally located between two shale rock beds. In this example, the coal exhibits a significantly lower level of natural radiation than the surrounding rock. Specifically, as the radiation passes through the coal from the rock, it is attenuated. It is this attenuation that is measured, by counting gamma rays that pass through the coal, to determine when cutting should be halted to avoid cutting into the rock. Each gamma ray produces a flash of light, or scintillation, when it penetrates a scintillation material inside a gamma detector. Counting gamma rays must be accomplished over a period of time because the nature of radiation is statistical, having an emission rate that is represented by a Gaussian distribution around some central value. Thus, a rise in the gamma count rate should signal proximity to the rock. By measuring the gamma count rate, the interface between the coal and the rock can be precisely determined. This precise determination allows the mining equipment to cut virtually the entire coal bed without cutting into the shale rock. This maximizes the coal mined while minimizing or eliminating the transporting of the rock out of the mine, the processing necessary to remove the rock from the coal, and the rock disposal cost.

Known techniques of mining for coal or ore are based on direct observations by the operator of the mining equipment. The operator knows the approximate location of the previous cut made by the mining equipment, and has a general awareness of the present location of the cutter drum. A clear view of the cutter, particularly when cutting at the floor, is not possible because the operator cannot get close enough to the cutter to see around the front of the miner and because of the dust and the water sprays. He must watch for any change in the color of the dust cloud which indicates rock penetration, and/or he listens for a change in the sound of the cutter drum. While this technique does work, it is rather imprecise and typically results in leaving a noticeable amount of coal or ore or the inclusion of a detrimental amount of rock in the coal or ore that is being mined. The most common result is to remove rock rather than to leave unmined coal. The operator is particularly challenged when making crosscuts from one room to another because his view is very limited as the miner cuts around a pillar. As a result, the mine operation must pay the high cost of removing and disposing of the rock from the coal/ore before it is sold.

In addition, the use of this manual technique requires the operator to be positioned as near to the cutter as possible, typically at the side of the miner. This is a high risk location, and numerous injuries and even deaths have resulted from working in this location. Having to be near the mineral face also significantly increases exposure to dust and noise, both of which are health hazards. Attempts to place the operator behind the miner have resulted in significant impairment of his ability to control the miner.

In mining operations, in order for a nuclear device, such as a gamma detector, to accurately detect the interface between the rock and the formation of interest (e.g. a coal bed) it must measure the distance between the tips of the picks on the cutter drum and the rock. This distance is the same as the thickness of the coal between the cutter picks and the rock. It is the thickness of the coal that can be measured by counting the gamma rays that pass through the coal. Optimal positioning of the gamma detector, therefore, is near the cutter. Only from this position is a change in the detector count rate as a function of the thickness of the coal between the cutter drum and the rock significant enough to be seen above statistical fluctuations that are inherent to all nuclear measurements. It is also important that the size of the field of view not be significantly reduced or increased by the movement of the cutter. Having the detector move along with the cutter is desirable.

Radiation is inversely proportional to distance, as exemplified by the ratio 1/r². Thus, by placing the gamma detector far back on the mining equipment and away from the cutting region, this alone significantly reduces the flux from the area near the cutter drum. In addition, the body of the mining equipment is between the detector and that region. This provides very effective shielding of the radiation that emanates from the rock near the cutter drum. These two factors combine to reduce the flux from the rock near the detector to very low levels.

Further, a detector far from the cutting region and positioned back on the mining equipment is surrounded by the rock exposed by earlier mining, and there is relatively little shielding from this exposed rock, compared to being mounted near the coal face, and in front of the miner. Thus, there will be a substantial radiation flux upon the detector from this non-target region. This results in a very low signal from the rock in front of the cutter compared with the background signal from exposed rock near the detector. After factoring in the statistical fluctuations inherent in any nuclear measurement and the relatively short sample time required by the speed of the mining operation, an unacceptably low signal to noise ratio is obtained.

The radiation flux from rock adjoining coal/ore usually originates from trace levels of radioactive potassium, uranium, or thorium that are found in the rock. While there is considerable variability in the concentration of these elements in earth formations, they are typically found in higher concentrations in the rock adjacent to mineral formations like coal than in the mineral formations themselves. Thus, the radiation level for bare rock is usually significantly higher than the radiation level in the middle of the vein of coal/ore. In an homogenous earth formation, an equilibrium radiation spectrum is seen. In a typical case, a discrete spectrum of gamma rays are produced by the radioactive decay of the trace elements mentioned above. These gamma rays are transported through the formation, losing energy through Compton scattering (and possibly pair production), until they are finally photoelectrically absorbed. The high energy regions of the radiation flux are not replenished, because the natural radioactivity of coal is much lower than that of the rock. As coal is removed and thereby is reduced in thickness, the gamma rays shift to sufficiently high energies so that absorption becomes a less significant factor.

FIG. 1 shows a typical equilibrium spectrum for a homogenous rock formation above and below a coal vein. The broad peak at about 100 kev is the downscatter peak. Most of the gamma radiation under this peak have lost energy through Compton scattering. If Compton scattering were the only physical process involved, a 1/E² distribution would be seen, instead of the downscatter peak that is seen. However, as gammas lose energy, their cross-section for photoelectric absorption increases. This absorption results in the gamma radiation having the lower energy, producing the backscatter peak that is observed in FIG. 1.

The formula for the photoelectric cross-section is given as:

$${P}_{e} = 0.01 barnes / electron \frac{{( \frac{Z}{10} )}^{3.6}}{{( \frac{E}{132 kev} )}^{3.15}} \qquad Eq . 1$$

where Z is the average atomic number of the formation. The denominator in this formula shows the strong energy dependence of the cross-section, and explains the existence of the backscatter peak. The numerator gives the dependence of the cross-section on the lithology of the formation.

An oilfield convention for describing this dependence is to consider the photoelectric cross section at E=30.6 kev. At this energy, the numerator =0.01 and we have:

$$Pe = {( \frac{Z}{10} )}^{3.6} barnes / electron \qquad Eq . 2$$

Using this convention, the photoelectric cross-section of coal is found to range from about 0.1 to about 0.3 barnes/electron, while the rock above and below the coal typically ranges from 2-5 barnes/electron. As a result, the downscatter peak for the rock above and below the coal is at a higher energy than the downscatter peak for coal.

It is somewhat easier to visualize these parameters by starting with only rock and adding coal on top of the rock, the reverse of cutting coal away. With the first thin layer of coal added on top of the rock, the spectrum is shifted to lower energies. Gamma rays from the rock lose energy as they are Compton scattered in the coal. The high energy regions of the flux are not replenished, because the natural radioactivity of the coal is much lower than that of the rock. As more coal is added, the gamma rays are shifted to sufficiently low energies to allow absorption to be a significant factor again.

FIG. 2 shows an example of this phenomenon, presenting the spectrum at the surface of bare rock (0 cm) and at the surface of a coal layer on top of that rock at distances of 10 cm and 20 cm from that rock. From the plots on FIG. 2, it is clear that the percent of flux per energy unit is greater at the rock face than that observed through a layer of coal.

One aspect of measuring the radiation from rock is the variety in the coal/ore and in the rock above or below the coal/ore. There are differing forms of rock that may be above or below a mineral vein. A typical coal formation, for example, might have fire clay under the coal and marine shale above the coal. In addition, at places, iron sulfide rocks or other materials may be in the vein, most often protruding down from the marine shale above the vein. A layer of shale may be located within the vein. The thickness of the rock may also vary. Further, the amount of released radiation varies, even within a mine. Sometimes, the radiation in one part of the formation, such as the roof, may be many times more intense than another part, such as the floor.

In addition, the mining process itself adds variability. The speed of the mining equipment will vary from cut to cut. The attitude of the mining equipment may change as a result of depth variations in previous cuts. During mining, a coal or rock pile is produced between the cutter drum and the body of the boom. This pile may vary in size, in density, and in elemental composition. These factors and others have prevented simplistic methods of mechanizing the cutting.

As explained above, the natural gamma count rate increases as the coal is removed and the distribution of the counts within various energy bands changes accordingly. The thickness of the remaining coal and the distance from the tips of cutter picks on the cutter and the rock is the same dimension. If the incremental movement of the cutter picks relative to the rock that is emitting the radiation can be accurately determined, then the changes in the gamma count rates can be correlated with those incremental changes in position. Through modeling and empirical data, the shape of a curve generated by this correlation can be used to more accurately calculate the thickness of the coal yet to be cut.

As noted above, the ideal place for a gamma detector is on the boom, near the cutter drum (FIG. 3). This location allows for a direct view of the coal formation that is being removed by the cutter. The most accurate measurements of the distance from the cutter to the rock to be avoided are obtained by placing the gamma detector near the region of the mineral being cut, rather than at a distance away or near some other region. Data must be accumulated over time in order to average the readings so as to establish that central value. Since the radiation in a coal mine is relatively weak, the view angle needs to be large in order to obtain data in a sufficiently short time in order to be used to control real-time cutting actions. But, large view angles in conventional devices have resulted in viewing radiation sources other than from the region that needs to be measured so this makes the measurement inaccurate. In other words, choosing a narrow viewing angle reduces the count rate, requiring more time or results in decreasing the accuracy. But, making the view angle wider also reduces the accuracy.

Attempts have been made to locate known gamma detectors on the cutting boom near the cutting region without success. See U.S. Pat. Nos. 3,591,235 (Addison), 4,262,964 (Ingle et al.), and 5,496,093 (Barlow). The area near the cutter is a very hostile environment for nuclear detectors. In this location, the detector package is subjected to the outflow from the cutter, resulting in massive shocks and high abrasion. Gamma detectors are sensitive and must be protected from harsh environments to survive and to produce accurate, noise free signals. This protection must include protection from physical shock and stress, including force, vibration, and abrasion, encountered during mining operations. However, the closer in proximity the gamma detector is to the mineral being mined, the greater is the shock, vibration and stress to which the detector is subjected. Thus, there is a tension between placing conventional gamma detectors close to the surface being mined to make accurate measurements and providing adequate protection to ensure survival of the sensor and to avoid degradation of the data by the effects of the harsh environment. Conventionally, the need to assure survival of the sensor has resulted in placement of the sensor away from the target of interest.

Accumulation of rock and coal debris on the miner in the vicinity of the detector adds uncertainty to the measurement in addition to the previously discussed factors. The detector requires both shielding and windows to have an adequate signal to noise ratio. Any detection system in a mining environment must first satisfy mine safety requirements by being placed in an explosion-proof container. The detector package must fit in the very limited available space. The detector itself must be of a minimum size, or else it will not have a counting rate that is sufficiently large to enable the signal to be statistically significant.

As a result of the severe environment near the material to be cut, gamma detectors have typically been located farther back on the mining equipment. Since this location is much more benign, and since there is typically more room available farther back on the mining equipment, it is far simpler to design a detector package for this location instead of close to the boom.

However, while a location farther back on the mining equipment simplifies the design process, it also degrades the performance of the detector, as previously explained. Even with an optimized window/shielding design, the signal from the region of the miner will be significantly smaller than the background from the exposed rock. This low signal to noise ratio, combined with the statistical uncertainty inherent in a nuclear measurement, has rendered known gamma detectors virtually worthless as a means of controlling the cutter.

Another conventional approach has been to make gamma detectors smaller so that they can be more easily placed in a strategically desirable location. However, the sensitivity of a smaller detector drops as the size is reduced, and again, the accuracy decreases in a corresponding fashion.

One method of mining coal/ore is continuous mining, in which tunnels are bored through the earth with a machine including a cutting drum attached to a movable boom. The operator of a continuous mining machine must control the mining machine with an obstructed view of the coal/ore being mined. This is because the operator is situated at a distance from the cuts made by the picks on the cutting drum and his view is obstructed by portions of the mining machine as well as dust created in the mining operation and water sprays provided by the miner. Another method of mining coal/ore is longwall mining, which also involves the use of two cutting drums, each attached to a boom called a ranging arm. In longwall mining, as compared with continuous mining, the drums cut a swath of earth up to one thousand feet at a time. Another method of mining coal is high wall mining. To accomplish this method using an unmanned mining machine, such as a continuous miner, the machine is operated by remote control. Typically, the operator relies upon video cameras and vibration sensors to control the cutting. Continuous mining machines, longwall mining machines, and high wall mining machines are used in very harsh conditions. The power supplies, amplifiers, processors, and other electronics are made fully safe by being enclosed within an explosion-proof housing.

Space for installing a gamma detector on a continuous miner is very limited since the detector must be positioned in a specific location in order to be in view of the coal to rock interface. The presence of armor, which is required to protect the detector, further limits the available space. An explosion-proof housing takes up even more of the available space, and often results in reducing the diameter of the photomultiplier tube. As the diameter of the photomultiplier tube is reduced, the efficient transfer of light to the tube becomes more critical. The optical coupling thus must be as thin as possible while remaining durable. Dynamic support elements must be very effective in protecting the detector from the harsh vibrations and shock but must also do so while consuming a small amount of space. Similarly, the outer portions of the detector, the armor, must provide a high level of shielding from unwanted radiation and must protect the detector from impact and abrasion, all with a minimal use of space.

### SUMMARY

The inventions provide a gamma detector which, in some aspects, may be utilized in mining applications, and in other aspects in oil well drilling and/or servicing operations. In one aspect of the inventions, the gamma detector includes a scintillation element, a housing or shield encompassing the scintillation element, a series of at least two thinned regions in the shield that essentially allow the scintillation element to be properly exposed to gamma radiation, a window optically coupled with an end of the scintillation element, and a photo-metric module optically coupled with the window.

In another aspect of the inventions the gamma detector is a part of a system for use on mining equipment. The system includes a gamma detector, which itself includes a scintillation element, a housing or shield encompassing the scintillation element, a window optically coupled with an end of the scintillation element, a photo-metric module optically coupled with the window, a rigid dynamic housing that encompasses the element, housing, window, and photo-metric module to provide dynamic support of the windows, and at least one window allowing the scintillation element to be exposed to gamma radiation.

In one aspect of the system, an armor material is positioned to protect the gamma detector from flying debris and forces from the cutter that are transmitted through the debris. Further, one or more water sprays are included and the detector is positioned on the mining equipment where water sprays are needed.

In yet another aspect of the inventions, the gamma detector includes a scintillation element, an element housing encompassing the scintillation element, and a support sleeve having bends. One support sleeve is positioned between the scintillation element and the element housing. In one aspect of the invention, the gamma detector includes a photomultiplier tube, a photometric module, a rigid dynamic housing, explosion-proof housing, and a plurality of support sleeves, wherein one support sleeve is between the photometric module and the explosion-proof housing, and between the element housing, photomultiplier tube, and explosion-proof housing and the rigid dynamic housing.

The inventions further provide a method for mining ore with mining equipment including a cutting drum. The method comprising measuring gamma radiation through an ore vein with at least one gamma detector having a scintillation element, photomultiplier tube, and logic element, transforming the gamma radiation entering the scintillation element into light pulses, transmitting the light pulses to the photomultiplier tube which changes the light pulses into electric pulses, and controlling the cutting drum to inhibit the cutting drum from cutting through the ore vein and into adjacent rock strata.

These and other objects, advantages and features will be more readily understood from the following detailed description of preferred embodiments of the invention which is provided in connection with the accompanying drawings.

### BRIEF DESCRIPTION OF THE DRAWINGS

FIG. 1 is a plot showing a typical equilibrium energy spectrum for a homogenous rock formation above and below a coal vein.

FIG. 2 is a plot showing the effects of coal on a typical equilibrium energy spectrum for a homogenous rock formation.

FIG. 3 is a schematic view from a side of a continuous miner including a pair of rock detectors constructed in accordance with a preferred embodiment of the invention.

FIG. 4 is a another side view of the continuous miner of FIG. 3 with the cutter near the roof.

FIG. 5 is a top view of one of the rock detectors of FIG. 3.

FIG. 6 is a cross-sectional view taken along line VI-VI of FIG. 5.

FIG. 7 is a close-up view taken within circle VII of FIG. 6.

FIG. 8 is a partial cross-sectional side view of one of the rock detectors of FIG. 3 showing an interface between the scintillation element and the photomultiplier tube.

FIG. 9 is a cross-sectional view taken along line IX-IX of FIG. 8.

FIG. 10 is a cross-sectional taken along line X-X of FIG. 8.

FIG. 11 is a cross-sectional view of a floor rock detector within a portion of the mining equipment.

FIG. 12 is a cross-sectional view of a roof detector within a portion of the mining equipment.

FIG. 13 is a side view of one of the flexible support sleeves of FIG. 10.

FIG. 14 is a cross-sectional view of a roof detector within a portion of the mining equipment constructed in accordance with another embodiment of the invention.

FIG. 15 is a block diagram of a rock detector in connection with other mining equipment constructed in accordance with another embodiment of the invention.

FIG. 16 is an alternative block diagram of a pair of rock detectors in connection with other mining equipment constructed in accordance with another embodiment of the invention.

FIG. 17 is an enlarged view of the circle XVII of FIG. 9.

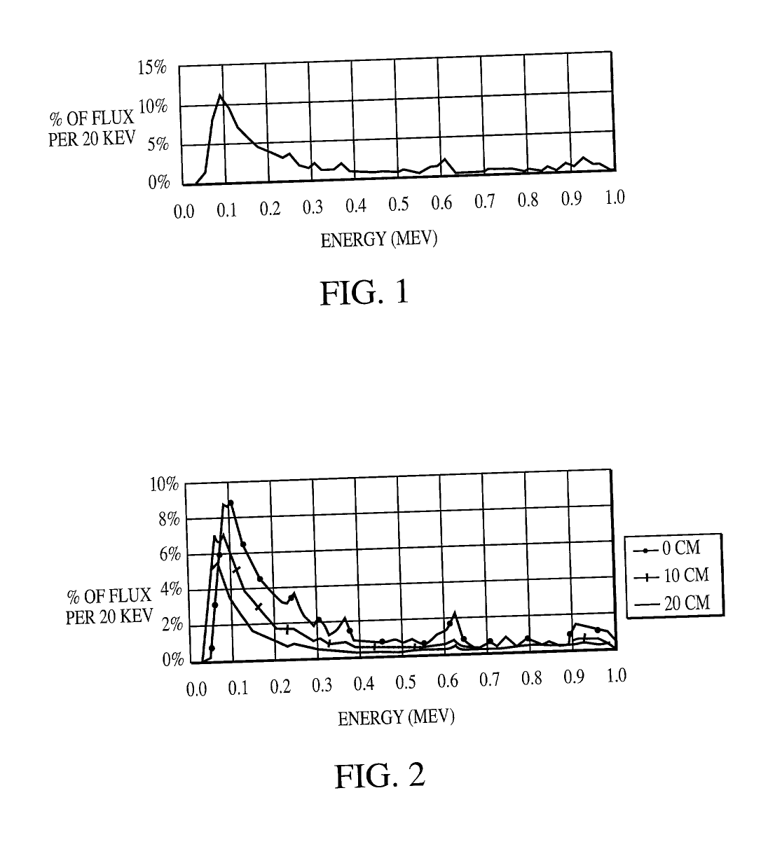

### DETAILED DESCRIPTION OF PREFERRED EMBODIMENTS

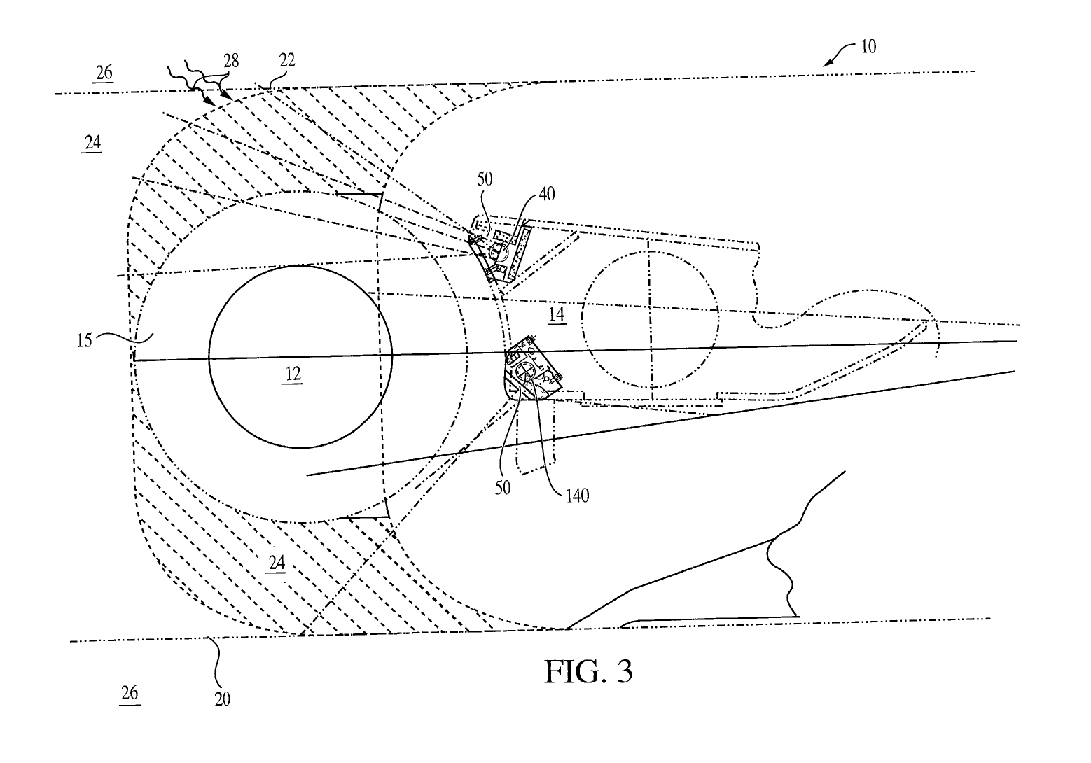

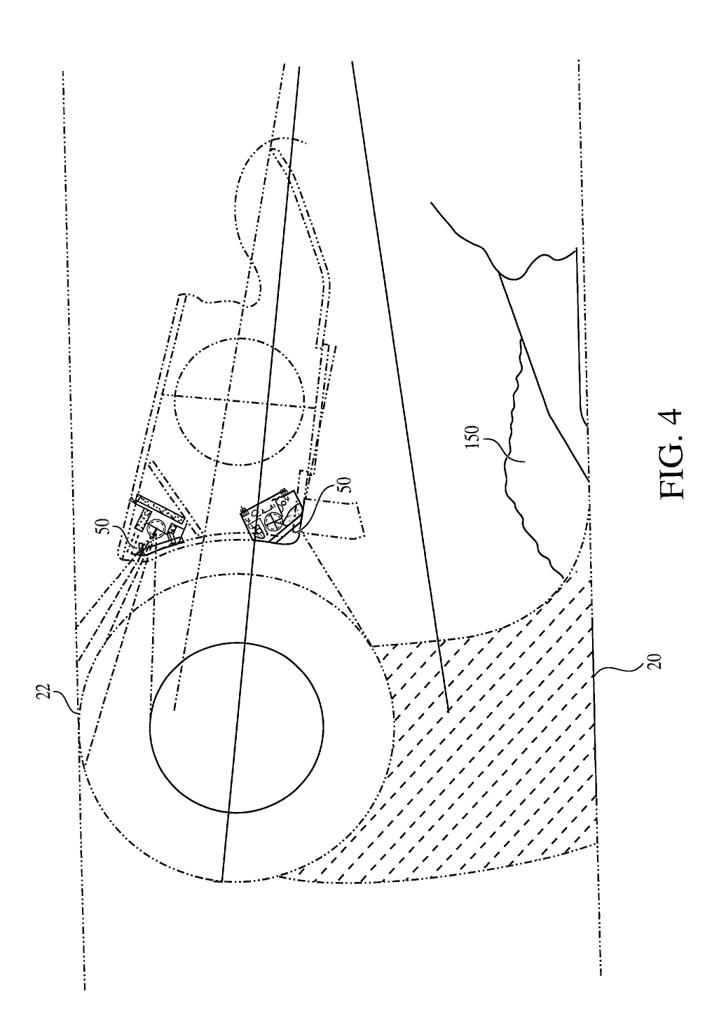

The invention will be described in preferred embodiments with reference to the above-noted figures. Mining equipment 10 is shown in FIGS. 3-4, including a pair of armored rock detectors 40, 140 within armor 50. The mining equipment 10 shown is a continuous mining machine. The mining equipment 10 includes a movable boom 14 attached to a cutting drum 12. The cutting drum 12 has an exterior surface upon which are mounted cutting tools or picks (not shown). The boom 14 is capable of being moved upward toward a roof coal-rock interface 22 and downward toward a floor coal-rock interface 20. The mining equipment can move forward into, and backward from, a layer of material 24 to be mined. While the material 24 may be any ore materials, for the purpose of simplicity, the material 24 will be described in terms of being coal. A surface 25 of the coal in front of the cutting drum 12 is termed a face.

The nearest point on the boom 14 to the coal-rock interfaces 20,22 is at the front of the boom 14, either at the top or the bottom edge. The armored rock detectors 40, 140 are advantageously located in, respectively, an upper portion and a lower portion of the boom 14. From either the upper or lower portions, the detector assemblies 40, 140 have a view between the picks on the cutting drum 12 to the respective floor or roof surface being cut. The view between the picks, generally designated as element 15, allows a view of the coal being cut, even after most of the coal has been cut away.

The detector assemblies 40, 140 further may be placed at any location laterally along the width of the mining boom 14. There may be instances where the positioning of the detector assemblies 40, 140 is more advantageous. For example, after the mining equipment 10 makes a first cutting pass, it may then reverse out from the coal layer 24, move laterally, and begin a second cutting pass. There will sometimes be overlap between the first and the second cutting passes. If the detector assemblies 40, 140 are positioned so as to have a view of uncut coal, even with the overlap, the detector assemblies 40, 140 may have more consistent viewing conditions. Yet, special needs may exist that cause other locations to be more favorable. For example, there can be a need for better viewing by the detector during the making of cross-cuts between rooms.

Generally, coal is found in strata sandwiched between a layer of impervious shale above and another layer of a rock material, such as, for example, fireclay below. Sometimes iron sulfide masses form in or beneath the shale layer. Iron sulfide masses are extremely dense, hard material which can damage the picks. In addition to determining the roof coal-rock interface 22, the rock detector 40 is capable of determining the presence of large iron sulfide masses. Thus, positioning the rock detector 40 in the upper portion of the boom 14 has the added benefit of inhibiting damage to the picks by advising the operator of the mining equipment 10 of the nearby presence of iron sulfide masses.

Vibration levels are high throughout the mining equipment 10, but are highest near the cutting drum 12. In addition to the vibration due to the rotation of the cutting drum 12 and the cutting action of the picks against the coal layer 24, the cutting drum 12 continually throws materials being mined at and onto the boom 14. Specifically, the cutting drum 12 throws material toward the boom 14, and rocks caught between the picks and the front of the boom 14 are driven against the boom with tons of force. High force impacts from the materials thrown onto the boom 14 are abrasive and can substantially erode the steel plates used in the boom 14. Any structure protruding from the surface of the boom 14 likely will be broken off due to the impacts from the materials that are thrown or pushed into the boom 14 by the picks. Thus, the armored rock detector 40 is formed of a material capable of being welded to the mining equipment 10. Preferably, part or all of the armored rock detector 40 is made from a high strength material, such as case hardened steel or a high strength steel alloy, that is adapted to highly attenuate gamma radiation. Further, the armored rock detectors 40, 140 are preferably mounted flush with the surface of the boom 14.

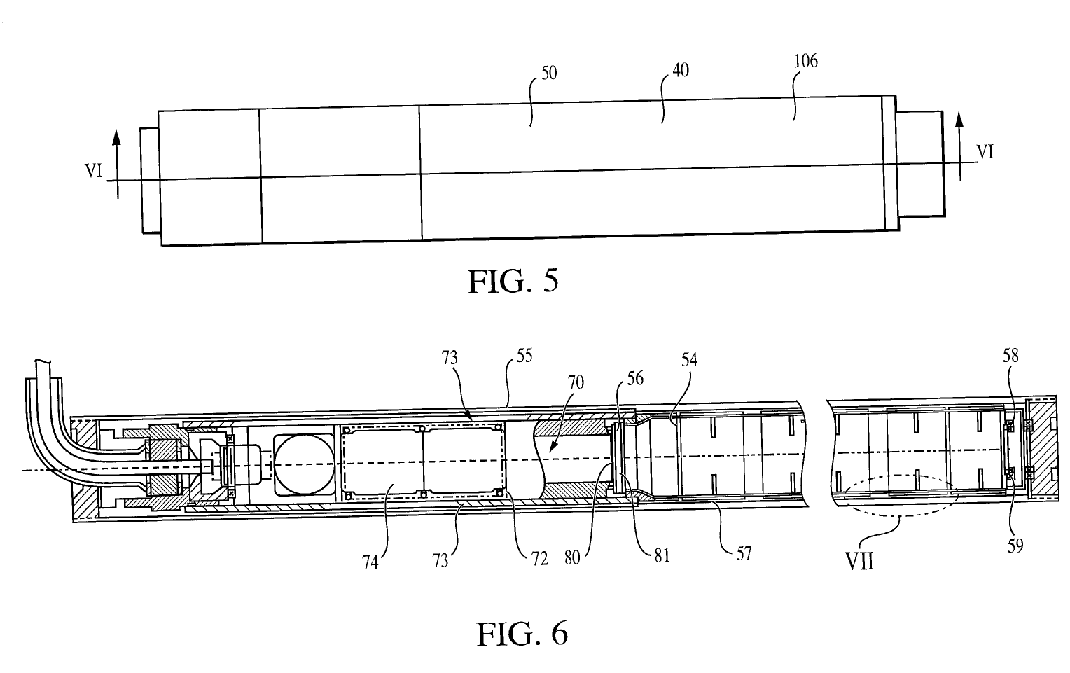

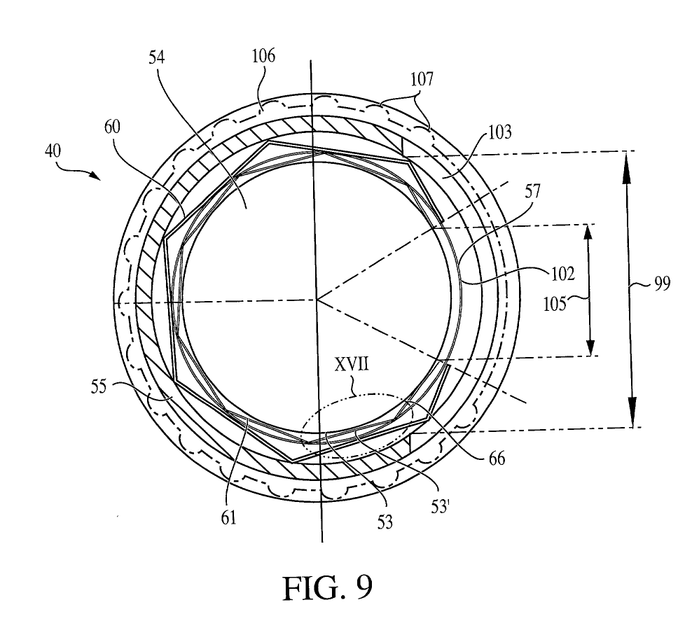

Referring now to FIGS. 3-14, the armored rock detectors 40, 140 are further described. FIG. 9 illustrates the rock detector 40 from an end showing a scintillation package which may include a fragile crystal or scintillation element 54 supported by a set of radial springs 66 inside a shield 57 and a flexible sleeve 60 between the shield 57 and a rigid dynamic enclosure 55. The metallic shield 57 hermetically seals the hygroscopically sensitive element 54 from moisture in the air and is part of the dynamic support system for the scintillation element 54.

Sodium iodide (NaI) crystals are typically selected as scintillation elements 54 because they have higher light output than other scintillation materials. However, sodium iodide crystals are fragile. One way of supporting the scintillation element 54, to protect against breakage, is to surround the element 54 with a set of radial springs 66, or instead a flexible support sleeve, such as the support sleeve 60, placed between the element 54 and the shield 57.

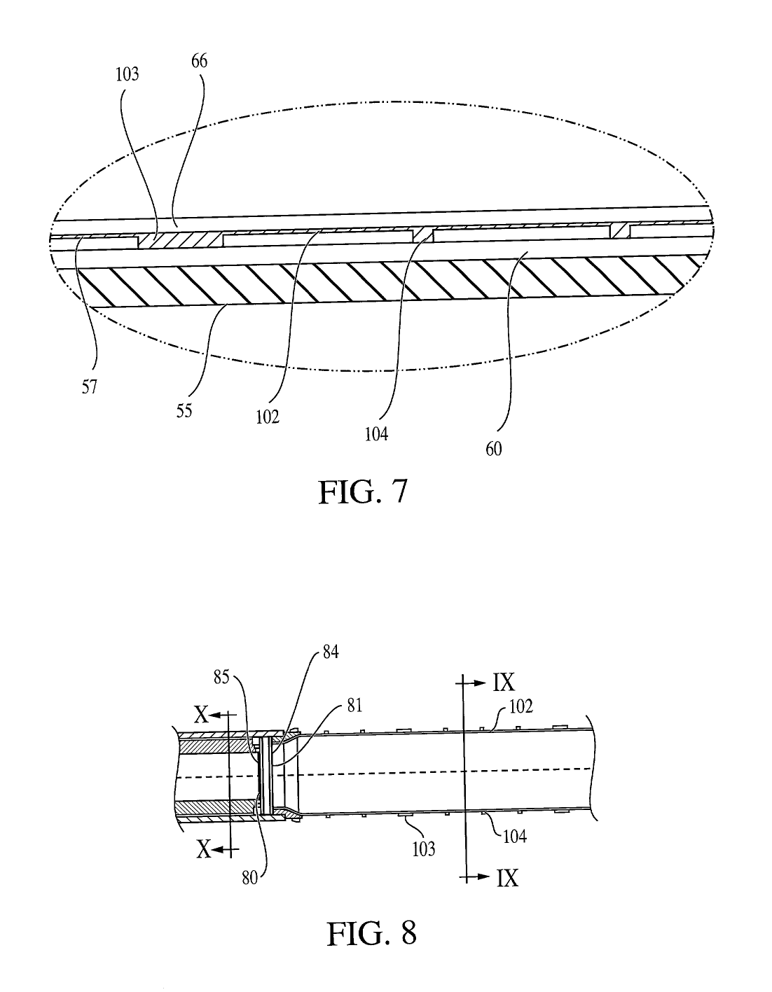

One consideration to be taken into account in designing the rock detector is to provide a clear pathway between the scintillation element 54 and the coal/rock from which the gamma rays 28 are being released. Since multiple layers and sub-assemblies are between the scintillation element 54 and the coal-rock interface, or target, 22, each layer and/or sub-assembly must provide a window or set of windows which are transparent to the gamma rays 28. The shield 57 includes thin titanium wall sections 102 (FIGS. 7-8), which preferably have a thickness in the range of about 0.01 inches to about 0.015 inches. Due to high levels of vibration and shock in the mining environment, however, such thin wall sections 102 do not provide adequate support for the scintillation element 54. Support for the element 54 is provided by stiffening rings 103 and 104 formed circumferentially around the shield 57 and supported by the flexible support sleeve 60. The rings 104 are formed to be wider than the rings 103. In addition, the support sleeve 60 is positioned around the shield 57 so as not to extend completely around the scintillation element 54, leaving a portion of the element 54 without the sleeve 60 in between it and the gamma rays 28. This portion is depicted in FIG. 9 as an opening 105. The opening 105 may not be as wide as the opening in the rigid dynamic enclosure 55, shown in FIG. 9 as opening 99, due to dynamic support requirements.

Providing low attenuation gamma windows in the scintillation shield 57 by use of the thin wall sections 102 and the support rings 103, 104 between the thin wall sections 102, the shield 57 may be used for any application in a rugged environment. This arrangement is beneficial when space for support structures is scarce. For example, this arrangement is useful in oil well drilling and servicing tools where space is limited inside the tools. Such an arrangement is compatible with the high temperatures experienced in oil wells, and applies to measure while drilling and wireless applications. The combination of radial springs 66, or a flexible support sleeve 60, inside the shield 57 and the flexible support sleeve 60 outside the shield 57 is a particularly efficient use of valuable space while providing uniform support along the length of the fragile scintillation element 54. By selecting the characteristics of the radial springs 66 (or inner support sleeve 60) to provide a resonant frequency at least 1.4 times the resonant frequency of the support sleeve 60 outside the shield 57, a high degree of protection is provided for the scintillation element 54. The outer support sleeve 60 prevents high frequencies from shock or vibration in the tool from entering the shield 57 and affecting the scintillation element 54, while the higher frequency of the radial springs 66 (or inner support sleeve 60) inhibits the scintillation element 54 from resonating with the outer support sleeve 60.

Both the radial springs 66 and the flexible support sleeves 60 can be designed and arranged within the detector so that a gap exists allowing incoming gamma rays to emanate to the scintillation element 54 with little obstructions (only that coming from the thin wall sections 102 of the shield 57). An additional benefit is that the springs 66 and the sleeves 60 are simpler to install than most other forms of dynamic support structures.

The extreme shock, vibration, impact, and abrasion environment on the front of the boom of a continuous miner or on the cowl of a long wall shearer requires that the scintillation element be supported to enhance its survivability in that environment. Certain aspects of the environmental considerations have been discussed above, but are discussed further below as to the affect on packaging of the scintillation element. A preferred embodiment for a scintillation element package that enhances survivability is depicted in FIGS. 9 and 17.

In the illustrated embodiment the scintillation element is a sodium iodide crystal because of its high light output. Sodium iodide crystals should preferably be protected from excessive shock and vibration and encased in a hermetically sealed housing, or shield.

There are other considerations, as mentioned above, for the packaging of sodium iodide crystals, or other types of scintillation elements, for use on mining equipment. For example, there is limited space available for locating the scintillation element for viewing of the area being cut. In order to withstand the high impact and abrasion from materials being thrown by the cutters, it is necessary for the rock detector, including the scintillator, to be protected by armor, which consumes some of the limited available space. Moreover, the electrical elements of the detector are enclosed in an explosion proof enclosure which must also be positioned inside armor for protection. Taken together, these combined space requirements dictate that each element use the limited space efficiently.

As discussed above, the scintillation element 54 should be able to receive gamma rays 28 from the rock 26 without excessive attenuation by the structures that make up the armored rock detector 40. This is accomplished in the illustrated embodiment by a series of special windows within the armored rock detector 40, 140. Also, preferably the rock detector 40 is be removable from the armor 50 for repair, replacement or upgrading, and is reinstallable in to the armor, in the field, because the armor is typically welded or otherwise essentially permanently attached to the mining equipment 10.

In the illustrated embodiment, the diameter of the crystal package is kept relatively small by the use of radial springs 66 or a flexible support sleeve 60. Flexible support sleeves have an additional advantage of being easier to install than radial springs. An important feature of the flexible support sleeve 60 is that a gap 105 can be left on one side which can be aligned with the opening 99 in the rigid dynamic housing 55 and with the PEEK window 42 in the armor 50.

Another approach to decreasing the use of space is to use a smaller photo-multiplier tube than would be typically employed. However, in order to achieve good performance, when using a smaller photo-multiplier tube, it is desirable that the scintillation element have sufficient light output and to maintain this output over an adequately long period of time while operating in the harsh environment. In the illustrated embodiment, this has been accomplished by arranging the elements around the crystal to enhance the preservation of the integrity of a reflector 53. A suitable reflector 53 is polytetrafluoroethylene tape or skived sheet that has been prepared specifically for optical applications. Strips of this tape, typically four inches wide, are wrapped around the crystal. Five to six layers are typically sufficient.

A reflective wrapping such as aluminized polyimide is applied over the reflector 53. This wrapping is held in place by strips of polyimide tape such as Kapton. This tape may be of any convenient width. Each strip is long enough to reach around the crystal and the joints are positioned away from the joint of the single wrap of the aluminized wrap.

Once a crystal has been prepared in this manner, it is then installed within the flexible support sleeve, which is in turn, installed into the shield 57. Assembled in this manner, the flat surfaces 61 of the flexible support sleeve 60 will be in contact with the outer layer, being the reflector 53, but not in contact with the areas between. Since, mining equipment is operated within modest temperature ranges, the crystal 54 will not be expanding much due to temperature changes, which allows selecting the dimensions of the sleeve 60 to provide low static forces. This is also made possible due to the fact that the accelerations in the longitudinal direction are small compared to the radial accelerations. Frictional restraint in the longitudinal direction may be kept low.

When this configuration is utilized, most of the reflector 53 is left in an uncompressed condition. This condition produces an effective reflective surface. During assembly, an optically reflective powder 253, such as alumina, may be added between the reflector 53 and the crystal surface so that even in the areas along the length of the crystal 54 where the flats 61 of the support sleeve 60 press against the crystal 54, the degrading effect of the pressure will be decreased by the powder 253.

While a scintillation package designed and prepared in this manner is advantageous to the mining application, it can also be effectively applied to oil well drilling applications. It is particularly well suited for wireline applications. Although wireline applications require operation at high temperatures up to 200° C., or more, the vibration and shock conditions are not continuous. Since the aluminized polyimide and the polyimide tape have coefficients of expansion close to that of the sodium iodide crystal, thermal cycling will not further compress the tape. Due to the reduced levels of shock and vibration, the static forces required by the flexible sleeve 60 can be kept somewhat lower, thus helping to reduce the compression of the reflector 53. In order to reduce wear on the tape by the support sleeve 60 when used in continuous vibration and shock in the longitudinal direction, as in some MWD oil drilling applications, a lubricating coating, such as a grease or a dry lubricant, can be applied to the inner surface of the support sleeve 60.

A typical size for the scintillation element 54 is 1.42 inches in diameter by 10 inches in length, but it may be as large as 2.0 inches in diameter or more. The light pulses created by the scintillation element 54 are transmitted through a window 84 to a photomultiplier tube 70, which transforms the light pulses into electrical signals. Specifically, light pulses from the scintillation element 54 pass through an optical coupler 81 (FIGS. 6,8), then through the sapphire window 84 positioned at an end of the shield 57, and finally through another optical coupler 82 into a faceplate 80 of the photomultiplier tube 70. The photomultiplier tube 70 and other electronics are part of a photo-metric module 72. The electrical signals transformed from the light pulses are analyzed to determine the distance to the coal-rock interfaces 20, 22. For example, count rates above a pre-selected energy level are measured and compared with an input or calibrated reference, or compared with the counts from the count rate earlier in the cutting cycle, and the logical commands are issued to slow down the movement of the boom 14 and then to stop the boom 14.

The scintillation element 54 extends between the end 58 and a window end 56 adjacent to the optical coupler 81. The scintillation element 54 is biased toward the optical coupler 81 through an axial spring 59 positioned at the end 58. On the other side of the window 84 is positioned the photo-metric module 72 which includes the photomultiplier tube 70 within the explosion-proof housing 73, and assorted electronics 74, such as power supplies, amplifiers, logic elements and other sensors. The photomultiplier tube 70 includes the faceplate 80 which has a micro-thin layer photo-cathode 78. Alternatively, a photodiode can be used instead of the photomultiplier tube 70.

In operation, the gamma radiation 28 (FIG. 3) passes through an elastomeric covering 106, the opening 99 in the rigid enclosure 55, and the opening 105 into the scintillation element 54 and is transformed by the scintillation element 54 into light pulses. The opening 105 is particularly beneficial for passing low energy gamma rays. The light pulses pass through the window 84 into the faceplate 80. As the light pulses pass through the photo-cathode 78, a few electrons are released from the photo-cathode 78. These few electrons are multiplied by the photomultiplier tube 70. The amplifier amplifies the signal before sending the signal and/or a count of the pulses through a cable to the miner control system (described in detail below).

An additional mechanism for protecting the fragile scintillation element 54 from breakage is the inclusion of the rigid dynamic enclosure 55 (FIG. 9) that provides additional vibration and shock isolation as well as protection from fluids and/or dust that enter the armor 50. The rigid dynamic enclosure 55 surrounds both the scintillation element 54 and the photo-metric module, providing mechanical protection for the scintillation element 54 and the photo-metric module 72 during handling in underground operations.

The elastomeric coating 106 with ridges 107 surrounds the enclosure 55. The ridges 107 provide mechanical compliance with armor 50, which will be described in detail below. The elastomeric coating 106 is, preferably, a durable water repellant coating, such as SYLGARD®, to prevent water, or other fluids or dust, from entering the opening 99 provided within the enclosure 55. The enclosure 55 and its contents can be transported from the underground environment to a laboratory where it can be opened for repair and/or replacement of its contents. A typical size for the enclosure 55 is about 2½ inches in diameter and twenty inches long. The opening 99, as shown in FIG. 9, represents an area of the enclosure 55 where there are multiple apertures, each separated by rings extending across the opening 99 and each including fingers that extend part of the way across the opening 99. The rings and fingers (not shown) provide mechanical support for the flexible support sleeve 60.

FIG. 6 shows that the shield 57 is connected with an explosion-proof housing 73, which encloses the photometric module 72 and other items described in detail below. Between the photometric module 72 and the explosion-proof housing 73 is a second set of radial springs 66, similar to those depicted in FIGS. 6-7, 9, surrounding the scintillation element 54. The springs 66 provide a level of dynamic isolation for the photometric module 72 and its contents, such as electronic elements 76, from externally induced vibration and shock.

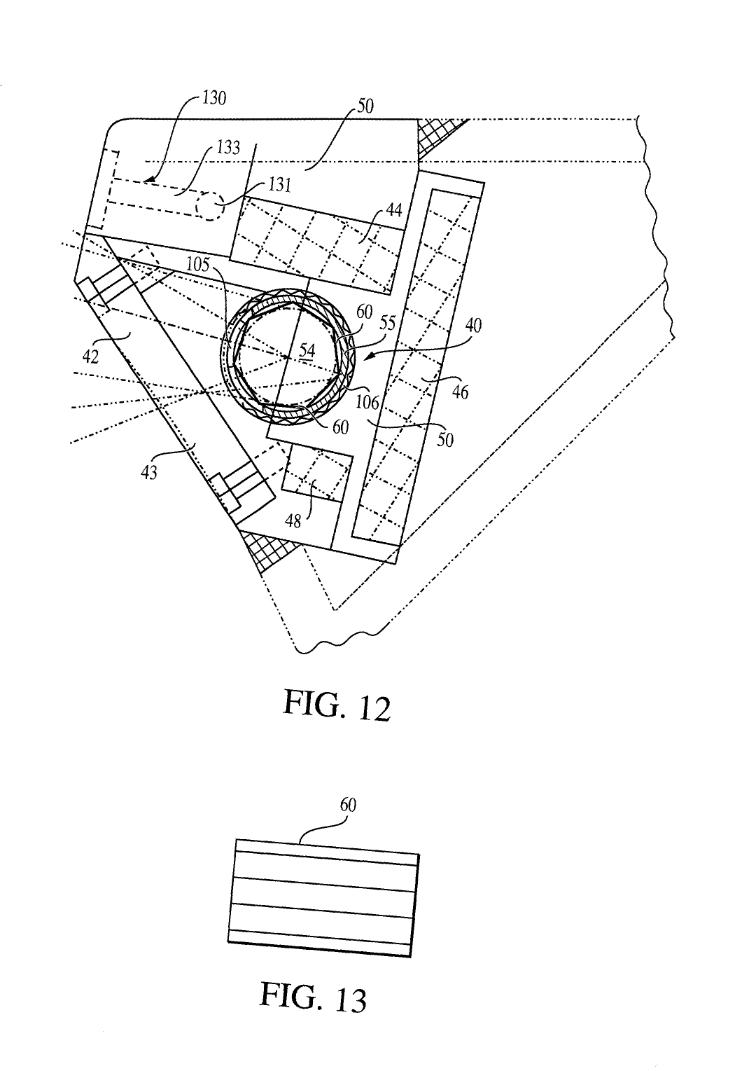

The dynamic enclosure 55 preferably is made of stainless steel or carbon steel and impedes gamma rays 28 from directions other than the interfaces 20, 22 from reaching the scintillation element 54. However, to achieve an acceptable signal-to-noise ratio, additional shielding is likely required. As shown in FIGS. 11-12, the armored rock detectors 40, 140 are surrounded by armor 50 as well as by lead shields 44, 46, 48. The armor 50 provides primary protection to the rock detectors 40, 140 against high forces and abrasion from materials being thrown and pushed by the cutter picks 15. The lead shields, which each extend longer than the element 54, serve to prevent high energy gamma radiation from entering the detector 40 and are protected by the armor 50. A lead plug (not shown) may be placed at the end 58 of the element 54. Further, the armor 50 and lead shields 44, 46, 48 are arranged so that whenever high energy gamma radiation enters the lead shields and produces lower energy radiation, a portion of the armor 50 will intercept the lower energy gamma rays as well. This arrangement of armor 50, lead shields 44, 46, 48 and plug improves the signal to noise ratio, thereby enhancing the performance of the rock detectors 40, 140.

The rock detectors 40, 140 are positioned to be protected by the armor 50 and the elastomeric covering 106 that encapsulates the rigid dynamic enclosure 55 (FIGS. 6-7, 9). The opening 99 in the rigid dynamic enclosure 55 is protected from impact and abrasion by windows 42 in the armor 50, which include a hardened, non-metallic material 43 which is relatively resistant to severe abrasion and shock while also being relatively transparent to gamma radiation 28 coming from the rock strata. Preferably, the material 43 includes polyether ether ketone (PEEK). Most preferably, the material 43 is a multi-layer woven carbon-fiber matrix which is impregnated by PEEK, with the carbon-fiber making up sixty percent by volume of the material 43. The alignment of the windows 42 with the gaps 99, 105 and the mininization of metal in this area allow for optimal amounts of gamma rays 28 to enter the scintillation element 54 without sacrificing protection of the element.

One issue encountered in mining applications is dust suppression to prevent ignition of the dust being generated by the cutters. As illustrated in FIG. 12, a spray mechanism 130 is positioned above the windows 42. The spray mechanism is integrated into the armor 50 and includes a spray nozzle 132, which is attached to a spray channel 133. The spray channel 133 is in fluid communication with a spray line 131 which provides to the spray mechanism 130 the fluid for spraying. The fluid travels from the spray line 131 through the spray channel 133 and out the spray nozzle 132.

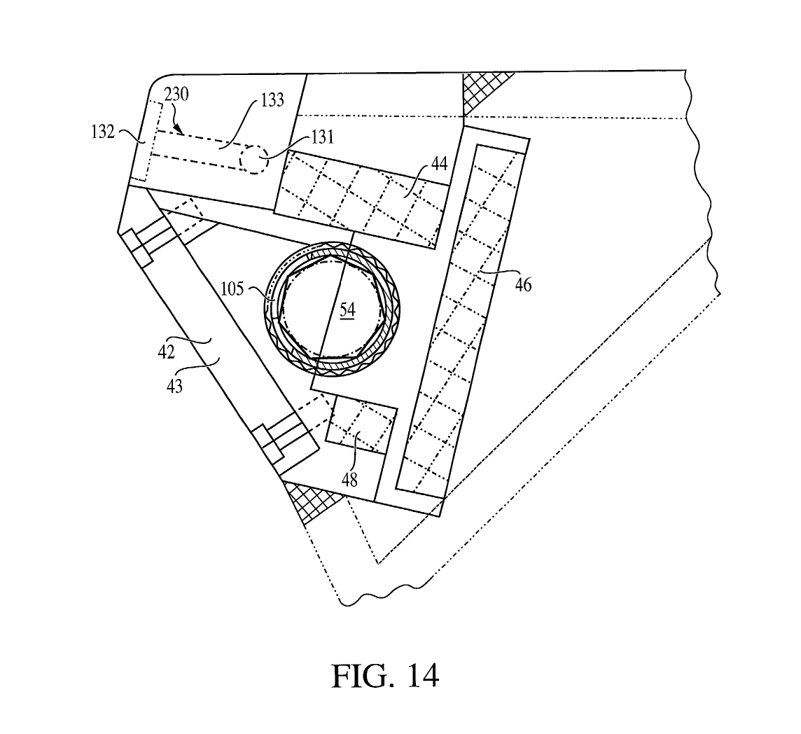

An alternative arrangement of a spray mechanism is shown in FIG. 14. Therein, a spray mechanism 230 is shown. The spray mechanism includes the spray nozzle 132, the spray channel 133 and the spray line 131. The spray mechanism 230 differs from the spray mechanism 130 in that the spray mechanism 230 is not integral with the armor 50, but instead is attached to the armor 50. The attachment of the spray mechanism 230 to the armor may be by way of bolts or by way of any of another suitable mechanical attachment structures and mechanisms, such as, heavy duty screws or welding.

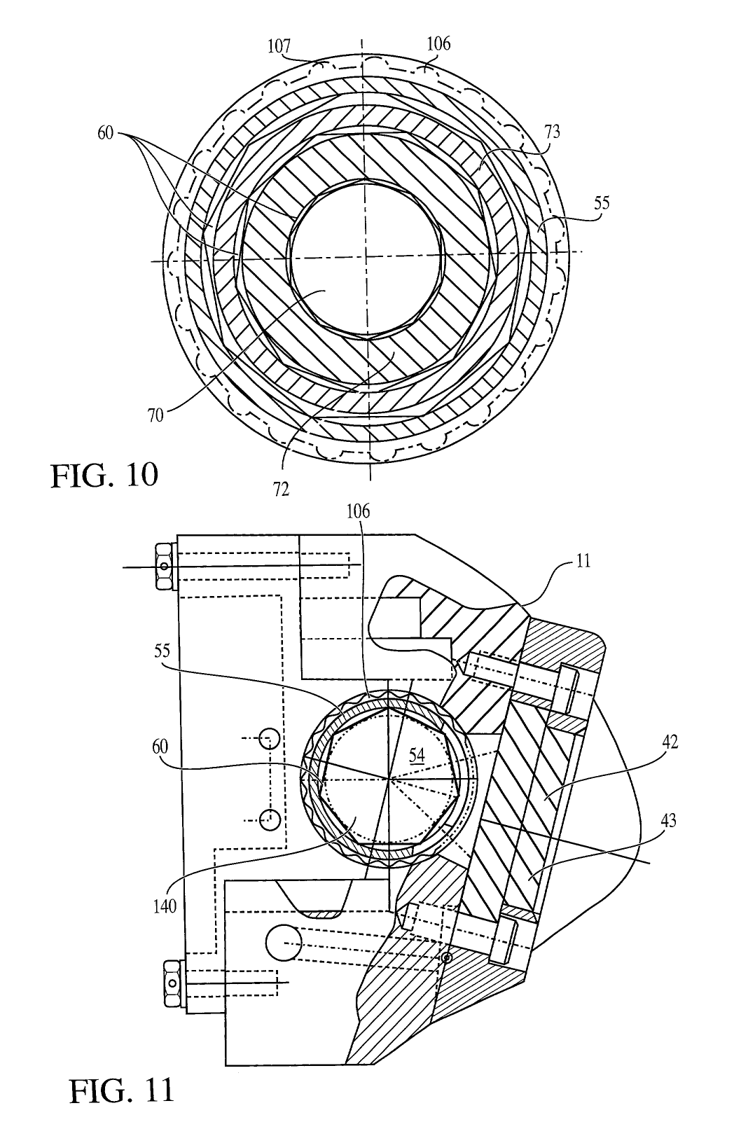

Referring to FIGS. 7,9-10, the support sleeves 60 and radial springs 66 will now be described. One aspect of the armored rock detector includes multiple support sleeves 60 either in conjunction with or without the radial springs 66. One sleeve 60 is placed around the photomultiplier tube 70 and within the photometric module 72, another is exterior to the housing of the photometric module 72 and inside the explosion-proof housing 73, while a third sleeve 60 is between the explosion-proof housing 73 and the rigid dynamic enclosure 55 (FIG. 10). Finally, as noted above, a sleeve 60 is positioned between the shield 57 and the rigid dynamic enclosure 55, and another sleeve 60 (or radial springs 66) is positioned between the shield 57 and the scintillation element 54 (FIG. 9). The support sleeves 60 are formed from a sheet of a metallic material, such as stainless steel. A purpose of the support sleeves 60 is to provide dynamic isolation for the scintillation element 54 and the electronics within the explosion-proof housing 73 from the harsh vibration and shock environment around the continuous miner. The sheet is bent at bends 62 which are aligned with the centerline of the element 54 to allow the sheet to be positioned around the element 54 as the sleeve 60. The characteristics of the sleeve 60 may be adjusted to achieve a desired resonant frequency within the enclosure 55. Specifically, the characteristics of the sleeve 60 may be adjusted by altering the spacing between the bends 62, altering the width, thickness or shape of the material making up the sleeve 60, and/or by altering the stiffness of the material making up the sleeve 60. The sleeve 60 may be formed of a material which is relatively transparent to radiation, and hence the sleeve 60 can extend across the openings 99, 105.

Alternatively, and as shown in FIG. 9, the sleeve 60 may be formed of a material which is not transparent to radiation, in which case the sleeve 60 should not extend circumferentially across the openings 99, 105 and between the scintillation element 54 and the windows 42 (FIG. 11-12). Preferably, the sleeve 60 is formed of stainless steel for optimal dynamic properties and durability. By tuning the resonant frequency of the element 54 with the sleeve 60, the element 54 can be isolated from higher resonant frequencies and can be inhibited from resonating with lower frequencies. The support sleeve 60 and the radial springs 66 for the scintillation element 54 preferably should be sized to be effective for a sodium iodide (NaI) crystal having a high length to diameter ratio since NaI crystals are easily fractured by vibration, shock, shear or bending forces. Selection of the dynamic and static forces characteristics of the sleeve 60 and the springs 66 must be chosen with particular care for this reason.

One of the support sleeves 60, or the radial springs 66 provides restraint of the element 54 in the longitudinal direction through its contact with the element 54. The restraining force is applied to the element 54 by the friction of the flat portions 61 of the sleeve 60 (or the radial springs 66) contacting the element 54 or any material, such as the reflector material 53 (FIG. 9), surrounding the element 54. A stiff configuration is produced in the longitudinal direction with the sleeve 60. If, however, dynamic forces exceed this restraining force, springs or pads at each end of the element 54 will arrest the movement of the element 54, thereby isolating the element 54 from the most damaging shocks and vibrations.

Another sleeve 60 may also be placed around the photomultiplier tube 70 within the photo-metric module 72 (FIG. 10). A typical shape for the sleeve 60 around the photomultiplier tube 70, as well as the other sleeves 60, is shown in FIG. 13. Another sleeve 60 may be placed between the photo-metric module 72 and the explosion-proof housing 73. The sleeve 60 between the rigid dynamic enclosure 55 and the housing 73 may extend along the entire length of the photo-metric module 72 and the scintillation shield 57 or only the length of the photomultiplier tube 70. The sleeve 60 immediately adjacent the photomultiplier tube 70 and the sleeve 60 (or radial springs 66) immediately adjacent the scintillation element 54 may be coated with a lubricant to facilitate movement. Preferably, the lubricant is a dry lubricant, such as a TEFLON® material.

The faceplate 80 of the photomultiplier tube 70 must optically couple to the window 84 to efficiently transfer light from the element 54 to the photo-cathode 78. An optical coupler, such as the coupler 82, may be molded onto the faceplate 80. Optical grease can then be applied to the window side of the coupler 82 prior to installation. Alternatively, the coupler 82 can be formed with concentric, oil-retaining rings and oil is used in lieu of grease. As the photo-metric module 72 is pushed into place within the explosion-proof housing 73, the photomultiplier tube 70 nears the window 84 until the optical coupler 82 with the optical grease contacts the window 84. As the photo-metric module 72 is pushed further into the explosion-proof housing 73, the photomultiplier tube 70 is pushed back into a cavity in the housing of the photo-metric module 72. The movement of the photomultiplier tube 70 relative to the sleeve 60 immediately surrounding the tube 70 may be facilitated by the dry lubricant. A spring in the cavity may be compressed between the photomultiplier tube 70 and housing of the photo-metric module 72 as the tube 70 moves back into the cavity. Through this arrangement, the photomulitplier tube 70 is held in alignment with the window 84 with a consistent uniform force, providing a good optical interface with, and good optical transfer through, the window 84 to the tube 70.

The presence of the sleeve 60 around the photo-metric module 72 not only provides dynamic support for the module 72, it also allows easy removal of the photo-metric module 72 from the explosion-proof housing 73 and provides good alignment relative to the window 84.

The illustrated embodiments of the invention also effectively solve the problem of electrically induced noise produced by electrical motors and other devices on the mining equipment. This is accomplished by placing critical electrical elements such as the photo-metric module 72, including the photomultiplier tube 70, power supplies, amplifiers, filters, discriminators, gain adjustment circuits, logic circuits and other electronics (i.e., ancillary electronics 74 and the logic element 76) within the explosion-proof housing 73. Electronic elements within the housing 73 are shielded from electromagnetic emissions from mining equipment. Amplifiers within the housing 73 boost the strength of the signals before they are transmitted from the detector to the control system for the miner. These specially conditioned and stronger signals are then essentially immune to the induced electromagnetic radiation as they pass through ruggedized cables to the miner control systems.

Mine safety requirements dictate that electrical and electronic equipment be housed in enclosures that are explosion-proof in order to prevent ignition of dust or gas that may be around the detector. A conventional approach is to place the gamma detector, including its photomultiplier tube inside an explosion-proof container. Other electronics necessary to support the detector would then be located inside another explosion-proof enclosure at another location. One unique feature of the illustrated embodiment is that the detectors 40, 140 are configured so that the explosion-proof requirement is met at the detector. Since detectors are needed near the cutter, then the explosion-proof container must be able to withstand shock, vibration, abrasion, and forces of many tons, without being damaged so as to lose its explosion-proof capability and thereby pose a safety hazard. Previous attempts to make such a container to be adequately strong and durable have resulted in the container being bulky and difficult or impossible to position where needed. Furthermore, there is a requirement for shielding, which has led conventional approaches to unworkable configurations. The current invention provides an explosion-proof container 73 which directly attaches to the scintillation element shield 57. The explosion-proof housing 73 encloses the photomultiplier tube 70 and also supporting electronics.

An aspect of the invention is that the rock detectors 40, 140 include their own explosion-proof housing 73, which is then fully protected by heavy armor 50, shielded by lead and dynamically protected by the flexible dynamic support sleeve 60. Also, having the explosion-proof housing 73 at the detector 40, 140 allows the electronics to be at the detector so that the sensitive, low level signals do not have to be transmitted outside the protective structures to electronics which have been located at some distance away, often many feet. In addition, the explosion-proof housing 73 is protected by the armor 50. The photomultiplier tube 70 and supporting electronics are protected by multiple levels of dynamic isolation and dampening, helping to ensure a longer life of the equipment.

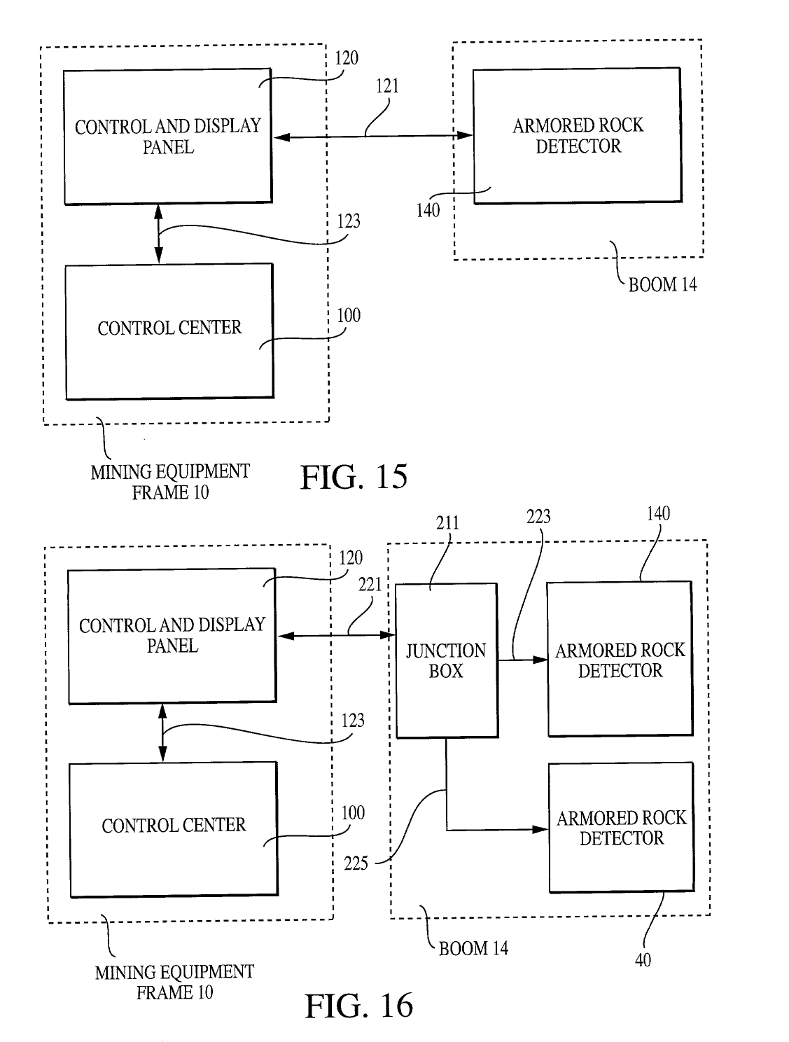

Nonetheless, electrical connections must be made between the rock detectors 40, 140 and a miner control center 100. FIGS. 15-16 illustrate simple arrangements for implementing, respectively, a single armored rock detector 40, and a pair of rock detectors 40, 140. So that the operator of continuous mining equipment 10 is enabled to make adjustments to the performance of the rock detectors 40, 140, a control and display panel 120 is required. The panel 120 may be stand alone as shown here or may be integrated into the miner control system 100. For example, if the operator determines that the rock detector 40 is currently tending to stop cutting short of reaching the rock, thus leaving some coal uncut, he can adjust for a deeper cut. If the operator determines that the armored rock detector 40 is cutting into rock, he can adjust the rock detector 40 to initiate a stop command earlier. Other information such as gamma count rates may be displayed so that the operator can assure himself that the rock detector 40 is properly counting. Electronics and software may also be included within the control and display panel 120 to make other decisions in support of the cutting operations. The control and display panel 120 may include a switch to turn power on and off to the rock detectors 40, 140.

As shown in FIG. 15, a cable 121, suitable for meeting MSHA safety requirements, is connected between the control and display panel 120 and the rock detector 140. The cable 121 must be routed inside the boom 14 and along the frame of the mining equipment 10 to the position selected to mount the control and display panel 120 for easy access by the operator. A second cable 123 is connected between the control and display panel 120 and the miner control center 100. Power is required by the rock detector 140 and the control and display panel 120, which is transmitted through the cable 123 to the control and display panel 120 and on to the rock detector 140 through the cable 121. Data from the rock detector 140 is sent to the control and display panel 120 through the cable 121, as well as stop or slow command decisions. The control and display panel 120 either transmits those decisions to the miner control center 100 through the cable 123 or it independently makes overriding decisions based upon the data and/or other data which may be available from the miner control center 100. The cables 121, 123 preferably would utilize a standard protocol, such as RS-232, RS-485, or IEEE 1394.

When two rock detectors 40, 140 are used, electrical junctions are required, and such junctions are required to be in an explosion-proof junction box 211, shown in FIG. 16. The junction box 211 is conveniently located toward the end of the boom 14 near the rock detectors 40, 140. Power and communications are both routed to the rock detectors 40, 140 through the junction box 211. Specifically, power and communications are transmitted between the control and display panel 120 and the junction box 211 via a MSHA approved cable 221 and between the control and display panel 120 and the miner control center 100 via the cable 123. Also, power and communications are transmitted between the rock detectors 140, 40 and the junction box 211 via, respectively, cables 223 and 225. The cables 223, 225 preferably would utilize a standard protocol, such as RS-232, RS-485, or IEEE 1394.

In situations where formation characteristics result in a miscalculation so that the cutter 12 removes all the coal and cuts through the rock interfaces 20, 22 into the rock, the rock detectors 40, 140 will detect that the cutter has overshot the interfaces 20, 22. The pile of coal 150 (FIG. 4) between the cutting drum 12 and the mining equipment 10 is covered by the rock that is now being mined. When this happens, there is a sharp rise in the count rate. This allows for a very clear determination that the coal/rock interfaces 20, 22 have been reached and a command is issued to stop the cutter.

The invention provides an armored detector system with logic elements for directing the operation of mining equipment, such as continuous mining machines. While the invention has been described in detail in connection with preferred embodiments known at the time, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. For example, although the illustrated embodiments are shown in connection with continuous mining machines, the invention may be adapted for other mining equipment for longwall mining and high wall mining. Accordingly, the invention is not to be seen as limited by the foregoing description, but is only limited by the scope of the appended claims.

What is claimed as new and desired to be protected by Letters Patent of the United States is:

1. A scintillation element package, comprising:
a scintillation element;
a shield encompassing said scintillation element; and
a flexible support sleeve at least partially surrounding said scintillation element within said shield, said flexible support sleeve providing dynamic support for said scintillation element.

2. The package of claim 1, wherein said first flexible support sleeve is formed of a material transparent to gamma radiation.

3. The package of claim 2, wherein said first flexible support sleeve is formed of stainless steel.

4. The package of claim 1, wherein said first flexible support sleeve includes bends and flat portions, said flat portions contacting said scintillation element and said bends contacting said shield.

5. The package of claim 4, wherein said bends promote friction between said shield and said first flexible support sleeve thereby suppressing relative movement between said shield and said first flexible support sleeve.

6. The package of claim 4, wherein said flat portions are coated on a surface facing said scintillation element.

7. The package of claim 6, wherein said flat portions are coated with a dry lubricant.

8. The package of claim 1, further comprising a reflector wrapped around said scintillation element.

9. The package of claim 8, further comprising an alumina powder between said reflector and said scintillation element.

10. The package of claim 8, wherein said reflector comprises polytetrafluorethylene.

11. The package of claim 8, wherein said reflector is in the form of a tape which is wrapped around said scintillation element.

12. The package of claim 8, wherein said reflector is in the form of a skived sheet.

13. The package of claim 8, further comprising a polyimide wrap surrounding said reflector.

14. The package of claim 13, further comprising a polyimide tape for holding said polyimide wrap in place.

15. The package of claim 14, further comprising a lubricant between said polyimide tape and said flexible support sleeve.

16. The package of claim 1, wherein said shield includes a plurality of stiffening rings.

17. A gamma detector, comprising:
a scintillation element; and
a first housing encompassing said scintillation element and including at least one window allowing said scintillation element to be exposed to gamma radiation, wherein said window is formed of a material including polyether ether ketone.

18. The gamma detector of claim 17, wherein said material forming said window is a multi-layer woven carbon-fiber matrix impregnated polyether ether ketone.

19. The gamma detector of claim 18, wherein said carbon fiber matrix makes up about sixty percent by volume of said material forming said window.

20. The gamma detector of claim 17, wherein said scintillation element comprises sodium iodide.

21. The gamma detector of claim 17, further comprising a photomultiplier tube.

22. The gamma detector of claim 21, wherein said photomultiplier tube includes a faceplate and a photo-cathode.

23. The gamma detector of claim 21, further comprising a buffer, amplifier, and peak detector.

24. The gamma detector of claim 21, further comprising an explosion-proof housing within said first housing and encasing said photomultiplier tube.

25. The gamma detector of claim 17, wherein said first housing comprises an armor material positioned to protect said gamma detector from flying debris.

26. The gamma detector of claim 25, further comprising a shield encompassing said scintillation element.

27. The gamma detector of claim 26, further comprising a rigid dynamic enclosure surrounding said shield and including an opening to allow gamma rays to enter said enclosure.

28. A gamma detector, comprising:
a scintillation element;
a shield surrounding said scintillation element; and
a first flexible support sleeve at least partially surrounding said scintillation element within said shield, said flexible support sleeve providing dynamic support for said scintillation element.

29. The gamma detector of claim 28, wherein said first flexible support sleeve is formed of a material transparent to gamma radiation.

30. The gamma detector of claim 29, wherein said first flexible support sleeve is formed of stainless steel.

31. The gamma detector of claim 28, wherein said first flexible support sleeve includes bends and flat portions, said flat portions contacting said scintillation element and said bends contacting said shield.

32. The gamma detector of claim 31, wherein said bends promote friction between said shield and said first flexible support sleeve thereby suppressing relative movement between said shield and said first flexible support sleeve.

33. The gamma detector of claim 31, wherein said flat portions are coated on a surface facing said scintillation element.

34. The gamma detector of claim 33, wherein said flat portions are coated with a dry lubricant.

35. The gamma detector of claim 28, wherein said shield includes a plurality of stiffening rings.

36. The gamma detector of claim 28, further comprising:
a rigid dynamic enclosure encompassing said shield; and
a second flexible support sleeve at least partially surrounding said shield within said rigid dynamic enclosure.

37. The gamma detector of claim 36, wherein said first and second flexible support sleeves each partially extend circumferentially around said scintillation element leaving a gap between said scintillation element and said rigid dynamic enclosure to allow entry of gamma rays.

38. The gamma detector of claim 37, wherein said rigid dynamic enclosure includes an opening and wherein said opening is aligned with and has at least as large a circumferential extent as said gap.

39. The gamma detector of claim 38, wherein said enclosure includes a plurality of rings and fingers, said rings completely extending across said opening and said fingers partially extending across said opening.

40. The gamma detector of claim 28, further comprising an optical coupler optically coupled to a first end of said scintillation element.

41. The gamma detector of claim 40, further comprising an axial spring positioned at a second end of said scintillation element to bias said scintillation element toward said optical coupler.

42. The gamma detector of claim 28, further comprising:
a photo-metric module within a module housing, said photo-metric module including a photomultiplier tube;
a window positioned between said photomultiplier tube and said scintillation element; and
a second flexible support sleeve surrounding said photomultiplier tube within said module housing, said second flexible support sleeve providing dynamic support for said photomultiplier tube.

43. The gamma detector of claim 42, wherein said photomultiplier tube includes a faceplate and a photo-cathode.

44. The gamma detector of claim 42, wherein said photo-metric module includes a buffer, amplifier, and peak detector.

45. The gamma detector of claim 42, further comprising:
an explosion-proof housing surrounding said module housing; and
a third flexible support sleeve surrounding said module housing within said explosion-proof housing, said third flexible support sleeve providing dynamic support for said photomultiplier tube.

46. The gamma detector of claim 45, further comprising:
a rigid dynamic enclosure encompassing said shield and said explosion-proof housing; and
a fourth flexible support sleeve surrounding said explosion-proof housing within said rigid dynamic enclosure, said fourth flexible support sleeve providing dynamic support for said photomultiplier tube.

47. A gamma detector system, comprising:
a gamma detector, including:
a scintillation element; and
a first housing encompassing said scintillation element and including at least one window allowing said scintillation element to be exposed to gamma radiation, wherein said window is formed of a material including polyether ether ketone;
armor material into which said gamma detector is located, said armor material for protecting said gamma detector from thrown debris; and
at least one spray mechanism for removing dust and thrown debris from said at least one window.

48. The gamma detector system of claim 47, wherein said spray mechanism is integral with said armor.

49. The gamma detector system of claim 47, wherein said spray mechanism is attached to said armor.

50. The gamma detector system of claim 47, wherein said spray mechanism comprises a sprayer in fluid connection with a spray line.

51. The gamma detector system of claim 47, wherein said spray line is connected to said sprayer by a spray channel.
